(19) United States
(12) Patent Application Publication
(10) Pub. No.: US 2022/0048514 A1
(43) Pub. Date: Feb. 17, 2022

(54) METHOD, APPARATUS, AND SYSTEM FOR DETECTING A SLIPPERY ROAD CONDITION BASED ON A FRICTION MEASUREMENT

(71) Applicant: HERE Global B.V., Eindhoven (NL)

(72) Inventor: Leon STENNETH, Chicago, IL (US)

(21) Appl. No.: 17/514,594

(22) Filed: Oct. 29, 2021

Related U.S. Application Data
(60) Provisional application No. 62/128,626, filed on Mar. 5, 2015.

(51) Int. Cl. B60W 30/18; G06K 9/62

(52) U.S. Cl. CPC B60W 30/18172; G06K 9/6288; B60W 2555/20; B60W 2552/20; B60W 2552/35

(57) ABSTRACT

An approach is provided for detecting a slippery road condition based on a friction measurement. The approach, for example, involves receiving a traction loss of a vehicle traveling on the road link. The traction loss is detected using a first sensor. The approach also involves receiving a coefficient of friction between the vehicle and a road surface of the road link. The coefficient of friction is measured using a second sensor. The approach further involves fusing the traction loss with the coefficient of friction to detect the slippery road condition on the road link. The approach further involves providing the detected slippery road condition as an output.

### RELATED APPLICATION

This application claims priority from U.S. Provisional Application Ser. No. 63/128,626, entitled “METHOD, APPARATUS, AND SYSTEM FOR DETECTING A SLIPPERY ROAD CONDITION BASED ON A FRICTION MEASUREMENT,” filed on Dec. 21, 2020, the contents of which are hereby incorporated herein in its entirety by this reference.

### BACKGROUND

Mapping and navigation service providers are continually challenged to provide new and compelling services. One area of development relates to developing the capability to measure real-time road conditions and provide services based on those conditions. For example, detecting and reporting conditions such as slippery road conditions presents significant technical challenges, for example, with respect to accuracy, timeliness, and coverage areas.

### SOME EXAMPLE EMBODIMENTS

Therefore, there is a need for an approach for detecting slippery road conditions based on friction measurements to increase coverage areas (e.g., geographic areas where slippery road condition data is available to customers) as well as accuracy (e.g., reduce false positive and/or negative detections).

According to one embodiment, a method for detecting a slippery road condition on a road link comprises receiving a traction loss of a vehicle traveling on the road link. The traction loss is detected using a first sensor. The method also comprises receiving a coefficient of friction between the vehicle and a road surface of the road link. The coefficient of friction is measured using a second sensor. The method further comprises fusing the traction loss with the coefficient of friction to detect the slippery road condition on the road link. The method further comprises providing the detected slippery road condition as an output.

According to another embodiment, an apparatus for detecting a slippery road condition on a road link comprises at least one processor, and at least one memory including computer program code for one or more computer programs, the at least one memory and the computer program code configured to, with the at least one processor, cause, at least in part, the apparatus to receive a traction loss of a vehicle traveling on the road link. The traction loss is detected using a first sensor. The apparatus is also caused to receive a coefficient of friction between the vehicle and a road surface of the road link. The coefficient of friction is measured using a second sensor. The apparatus is further caused to fuse the traction loss with the coefficient of friction to detect the slippery road condition on the road link. The apparatus is further caused to provide the detected slippery road condition as an output.

According to another embodiment, a computer-readable storage medium for detecting a slippery road condition on a road link carries one or more sequences of one or more instructions which, when executed by one or more processors, cause, at least in part, an apparatus to receive a traction loss of a vehicle traveling on the road link. The traction loss is detected using a first sensor. The apparatus is also caused to receive a coefficient of friction between the vehicle and a road surface of the road link. The coefficient of friction is measured using a second sensor. The apparatus is further caused to fuse the traction loss with the coefficient of friction to detect the slippery road condition on the road link. The apparatus is further caused to provide the detected slippery road condition as an output.

According to another embodiment, an apparatus for detecting a slippery road condition on a road link comprises means for receiving a traction loss of a vehicle traveling on the road link. The traction loss is detected using a first sensor. The apparatus also comprises means for receiving a coefficient of friction between the vehicle and a road surface of the road link. The coefficient of friction is measured using a second sensor. The apparatus further comprises means for fusing the traction loss with the coefficient of friction to detect the slippery road condition on the road link. The apparatus further comprises means for providing the detected slippery road condition as an output.

According to one embodiment, a method for detecting a slippery road condition on a road link comprises receiving a coefficient of friction between a vehicle and a road surface of the road link. The coefficient of friction is measured using a sensor. The method also comprises determining a negative observation of the slippery road condition based on determining that the coefficient of friction is above a threshold value. The negative observation indicates that the slippery road condition has not been detected based on the measured coefficient of friction. The method further comprises determining the slippery road condition of the road link based on the negative observation.

According to another embodiment, an apparatus for detecting a slippery road condition on a road link comprises at least one processor, and at least one memory including computer program code for one or more computer programs, the at least one memory and the computer program code configured to, with the at least one processor, cause, at least in part, the apparatus to receive a coefficient of friction between a vehicle and a road surface of the road link. The coefficient of friction is measured using a sensor. The apparatus is also caused to determine a negative observation of the slippery road condition based on determining that the coefficient of friction is above a threshold value. The negative observation indicates that the slippery road condition has not been detected based on the measured coefficient of friction. The apparatus is further caused to determine the slippery road condition of the road link based on the negative observation.

According to another embodiment, a computer-readable storage medium for detecting a slippery road condition on a road link carries one or more sequences of one or more instructions which, when executed by one or more processors, cause, at least in part, an apparatus to detected a coefficient of friction between a vehicle and a road surface of the road link, the coefficient of friction is measured using a sensor. The apparatus is also caused to determine a negative observation of the slippery road condition based on determining that the coefficient of friction is above a threshold value. The negative observation indicates that the slippery road condition has not been detected based on the measured coefficient of friction. The apparatus is further caused to determine the slippery road condition of the road link based on the negative observation.

According to another embodiment, an apparatus for detecting a slippery road condition on a road link comprises means for receiving a coefficient of friction between a vehicle and a road surface of the road link. The coefficient of friction is measured using a sensor. The apparatus also comprises means for determining a negative observation of the slippery road condition based on determining that the coefficient of friction is above a threshold value. The negative observation indicates that the slippery road condition has not been detected based on the measured coefficient of friction. The apparatus further comprises means for determining the slippery road condition of the road link based on the negative observation.

According to another embodiment, the method, the apparatus, or the computer-readable storage can be applied by one or more of the at least two devices to detect the joint motion between the at least two devices. In other words, a first device of the at least two devices can perform the embodiments described herein to detect joint motion alone or in combination with a second device of the at least two devices, a cloud component, or a combination thereof.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing a method of any of the claims.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of detecting slippery roads based on friction measurements, according to one embodiment;

FIG. 2 is a diagram of components of a mapping platform capable of detecting slippery roads based on friction measurements, according to one embodiment;

FIG. 3 is a flowchart of a process for detecting slippery roads based on friction measurements, according to one embodiment;

FIGS. 4A and 4B are diagrams of friction measurements over example road links, according to various embodiments;

FIG. 5 is a diagram illustrating an example of fusing traction loss and friction measurements, according to one embodiment;

FIG. 6 is a diagram illustrating a distribution of coefficient of friction data, according to one embodiment;

FIG. 7 is a diagram illustrating a measuring correlation based on true positives, according to one embodiment;

FIGS. 8A and 8B are diagrams illustrating different slippery road condition distributions respectively using traction loss versus using friction measurements, according to one embodiment;

FIGS. 9A and 9B are example user interfaces for presenting slippery road condition data, according to various embodiments;

FIG. 10 is a flowchart of a process for detecting slippery road conditions using negative observations and positive observations determined from friction measurements, according to one embodiment;

FIG. 11 is a diagram of an example user interface for presenting negative and positive observations of slippery road conditions based on negative observations and positive observations, according to one embodiment;

FIG. 12 is a diagram of a geographic database, according to one embodiment;

FIG. 13 is a diagram of hardware that can be used to implement an embodiment;

FIG. 14 is a diagram of a chip set that can be used to implement an embodiment; and

FIG. 15 is a diagram of a mobile terminal that can be used to implement an embodiment.

### DESCRIPTION OF SOME EMBODIMENTS

Examples of a method, apparatus, and computer program for detecting slippery road conditions based on friction measurements are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

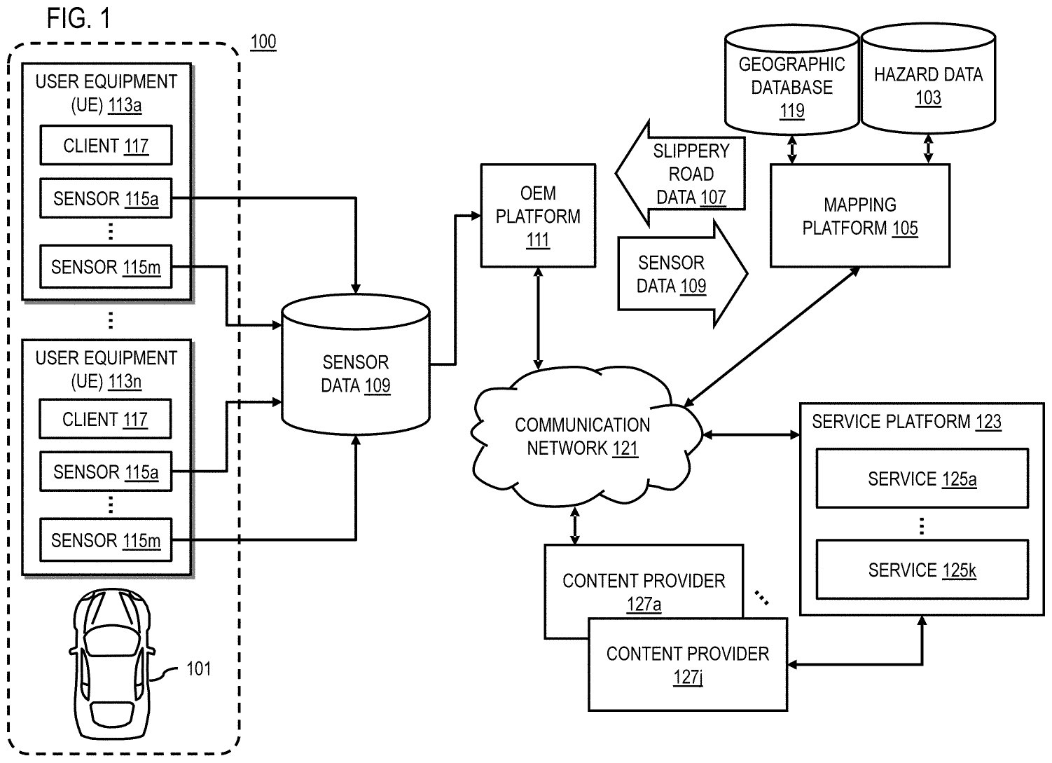

FIG. 1 is a diagram of a system capable of detecting slippery roads based on friction measurements, according to one embodiment. The various embodiments described herein relate to autonomous vehicles (e.g., vehicle 101), hazard warning product (e.g., hazard data 103) of a mapping platform 105, and slippery road warnings/alerts (e.g., slippery road data 107). In one embodiment, the slippery road product or data 107 uses the input data (e.g. sensor data 109) from the vehicles 101 associated with an Original Equipment Manufacturer (OEM) platform 111. An OEM platform 111, for instance, is operated or associated with an automobile manufacturer and serves as the intermediary server that anonymizes data between (a) OEM vehicles 101 and/or associated User Equipment (UE) devices 113a-113n (also collectively referred to as UEs 113) and (b) any other component of the system 100. The vehicles 101 and UEs 113 can be equipped with respective sensors 115a-115m (also collectively referred to sensors 115) for detecting traction loss and/or measuring coefficients of friction (e.g., friction measurements) to be reported as sensor data 109 according to the embodiments described herein. The vehicles 101 and/or UEs 113 can execute or include client applications 117 (e.g., clients 117 of the mapping platform 105 or other location-based services/applications). In some embodiments, the input data (e.g., sensor data 109) can be transmitted directly from the vehicles 101 and/or UEs 113 to the mapping platform 105 without the OEM platform 111. Similarly, the mapping platform 105 can also convey the slippery road data 107 and/or other hazard data 103 directly to the vehicles 101 and/or UEs 113 or indirectly via the OEM platform 111.

In one embodiment, the input or sensor data 109 represents traction loss indicated by one or more sensors 115 including, but not limited to, the Anti-lock Braking System (ABS) and Electronic Stability Control (ESC lateral) sensors that are on the vehicle 101 or UEs 113. In some cases, due to driver behavior, it is possible to have traction loss even when the roads are not actually slippery. For example, this can happen when a driver accelerates too quickly from an intersection or brakes/accelerates on gravel road to cause a loss of traction (as opposed to loss of traction due to slippery conditions). For this reason, by using traction loss alone as an indicator of a slippery road, most of the current slippery road alerts (e.g., indicated in the slippery road data 107) are on lower functional class (FC) roads (e.g., FC4 and FC5) since these roads have more intersections than higher functional classes (e.g., FC1) such as highways. Accordingly, mapping service providers face significant technical challenges to determining slippery road data 107.

To address these technical challenges, the system 100 introduces a capability to measure the coefficient of friction between the vehicle 101 (e.g., between the tire of the vehicle 101) and the pavement or road surface on which it is driving to determine slippery road conditions in addition to or in place of detecting traction loss as a proxy for slippery road conditions. In one embodiment, the system 100 measures the coefficient of friction between the vehicle and the pavement as a continuous number between 0 (slippery) and 1 (not slippery) and then generates slippery road alerts based on a threshold cut on the measured coefficient of friction. By way of example, the coefficient of friction can be measure based on the friction between the vehicle 101's tire and the road surface using any means including, but not limited to, tire grip measurements, wheel spin measurements, and/or equivalent. In addition or alternatively, sensors such as imaging sensors (e.g., to detect visible signs of slipperiness), thermal sensors (e.g., to detect road temperatures associated with slipperiness), and/or equivalent can be used to measure coefficient of friction values for use in detecting slippery road conditions according to the embodiments described herein.

In one embodiment, the friction measurements can be made continuously by the vehicle 101 as it travels. This continuous measurement enables the system 100 to utilize continuous real-time monitoring of the coefficient of friction (e.g., indicated by tire grip measurements or other equivalent friction measurement) of the vehicle 101 in place or in addition to traction loss measurements (e.g., as determined using ABS, ESC, or equivalent traction loss sensor data). By directly measuring coefficient of friction, the system 100 advantageously avoids needing driver input (e.g., accelerating or braking) to detect potential slippery road conditions. Other examples of such user behavior is traction loss at intersections or traffic lights due to high acceleration, on gravel roads due to high acceleration/braking, etc.

As noted above, in the various embodiments described herein, instead of or in addition to using traction loss (e.g., from ABS and ESC sensors), the system 100 measures the coefficient of friction between the vehicle 101 (e.g., vehicle tire as a proxy) and the pavement as a continuous number between a designated range, e.g., 0 (extremely slippery) and 1 (not slippery). The vehicles 101, for instance, are equipped with tire grip sensors or other equivalent coefficient of friction sensors capable of generating continuous friction values. The system 100 then generates slippery road alerts or other slippery road data 107 (e.g., hazard data 103) based on a threshold cut on the measured coefficient of friction. The slippery road data 107 can be mapped to digital map data (e.g., map data of the geographic database 119) to associate the slippery road data 107 to corresponding road links, portions thereof, or other map features. The resulting slippery road data 107 can then be transmitted to the vehicle 101 and/or UE 113 directly or indirectly via the OEM platform 111 over a communication network 121. For example, if the message flow is via the OEM platform 111, the OEM platform 111 can anonymize the sensor data 109 for processing by the mapping platform 105 and then deanonymize the received slippery road data 107 before transmitting the deanonymized slippery road data 107 to the corresponding OEM vehicle 101 and/or UE 113.

In one embodiment, the raw coefficient of friction is used to warn drivers if it is below a threshold. The system 100 can also advantageously values above the threshold as negative observations of slippery road conditions. A negative observation, for instance, indicates that a friction measurement was made on a road link or segment and the system 100 has determined that no slippery condition is indicated by the measured data. The system 100 can then take the negative observations into consideration along with any positive observations. Taking negative observations into consideration advantageously enables the system 100 to make more accurate estimation of the actual slipperiness, for instance, because of the increased total number of observations (e.g., both negative and positive) to make a determination. For example, assume that 10 vehicles drove on a segment and 6 reported coefficients of friction below the threshold and 4 reported coefficients of friction above the threshold (i.e., negative observations), then the system 100 would have a total of 10 observations by using both positive and negative observation while an approach relying on just positive observations would have just 6 observations (e.g., positive observations only).

In one embodiment, the system 100 enables the detection of slippery road conditions at a higher level of granularity. For example, in one embodiment, the system 100 works at a 5 m granularity (or better) to account for lane level changes. In other words, the system 100 can determine slippery road conditions at a granularity level that is sufficient (e.g., 5 m or better) to distinguish between differences in slipperiness between different lanes of a multi-lane road link. For example, in a snowstorm, one lane may be plowed (e.g., providing improved traction and less slipperiness) while another lane may be unplowed (e.g., resulting in lower friction and more slipperiness). By having this data, in one embodiment, the system 100 can provide lane level routing that provides the greatest traction or avoids lanes that have detected slippery conditions.

In one embodiment, the system 100 can combine traction loss (e.g., from ABS and/or ESC sensor) and friction measurements by first converting the point-based traction loss events to line based events. After converting point-based traction loss events to lines, the system 100 does a purely line based fusion with the already collected friction-based measurements. In one embodiment, the fusion is spatio-temporal (e.g., traction loss and friction measurements are 50 m of each other and within 30 minutes of each other). Other example constraints may include, but is not limited to, both traction loss and friction observation should be on the same map link or a connected map link to account for intersections and in the same travel direction.

As discussed, coefficients of friction between the vehicle/tire and the pavement is continuously monitored. For example, continuous monitoring can refer to a vehicle 101 being configured to collect friction measurements at a designated frequency as it drives or travels over a road network. In this way, the friction measurements can be provided a real-time stream to OEM platform 111 and/or mapping platform 105 or provided in batches as they are collected. In another embodiment, the friction measurements can be process locally on the vehicle 101 and/or UE 113 (e.g., via the client 117).

In one embodiment, the system 100 considers just the friction measurements and/or detected traction loss to make a slippery road determination. In other words, in one embodiment, the system 100 does not consider, for instance, online weather since many vehicles are not equipped access to online weather data (or any other supplemental data type) for free and also since the system 100 is generally working at very low spatial resolution, weather data does not change that much across a few meters (e.g., the spatial resolution of the slipperiness determination according to one embodiment).

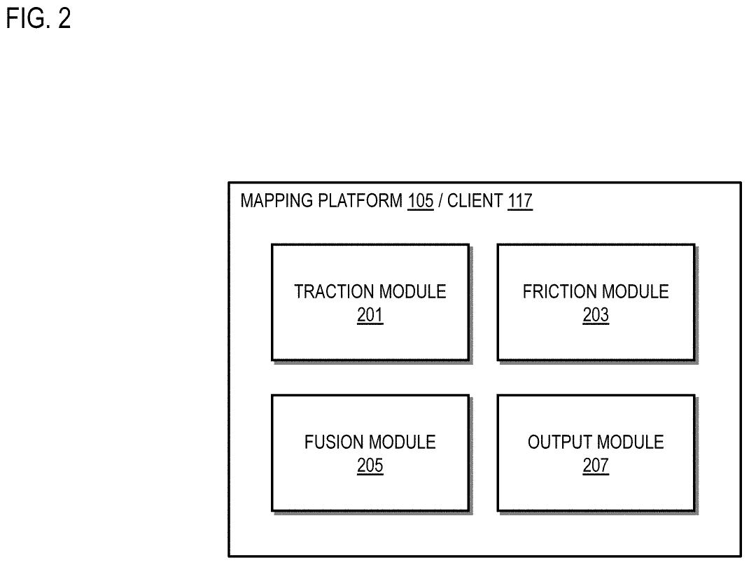

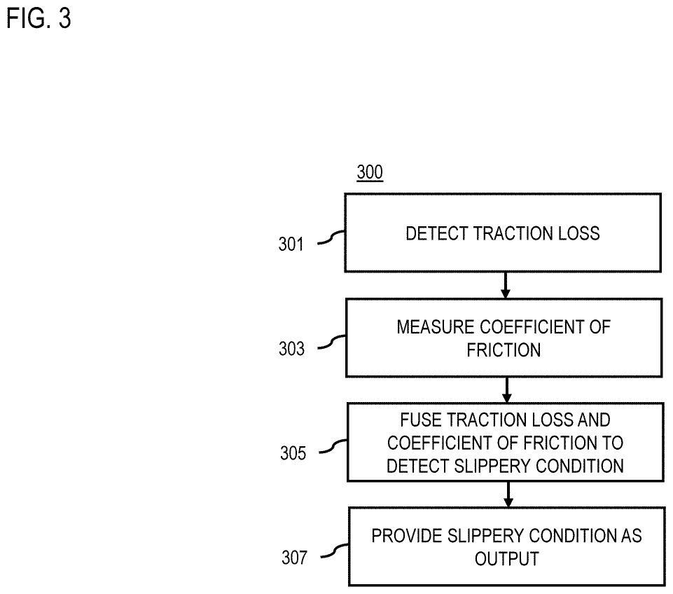

In one embodiment, as shown in FIG. 2, the mapping platform 105 or mapping client 117 of the system 100 includes one or more components for detecting slippery road conditions based on friction measurements according to the various embodiments described herein. It is contemplated that the functions of the components of the mapping platform 105 and/or client 117 may be combined or performed by other components of equivalent functionality. As shown, in one embodiment, the mapping platform 105 and/or client 117 includes a traction module 201, a friction module 203, a fusion module 205, and an output module 207. The above presented modules and components of the mapping platform 105 and/or client 117 can be implemented in hardware, firmware, software, or a combination thereof. Though depicted as a separate entity in FIG. 1, it is contemplated that the mapping platform 105 may be implemented as a module of any of the components of the system 100 (e.g., a component of a services platform 123, one or more services 125a-125k (also collectively referred to as services 125), content providers 127a-127j (also collectively referred to as content providers 127), and/or the like). In another embodiment, one or more of the modules 201-207 may be implemented as a cloud-based service, local service, native application, or combination thereof. The functions of the mapping platform 105, client 117, and modules 201-207 are discussed with respect to FIGS. 3-11 below.

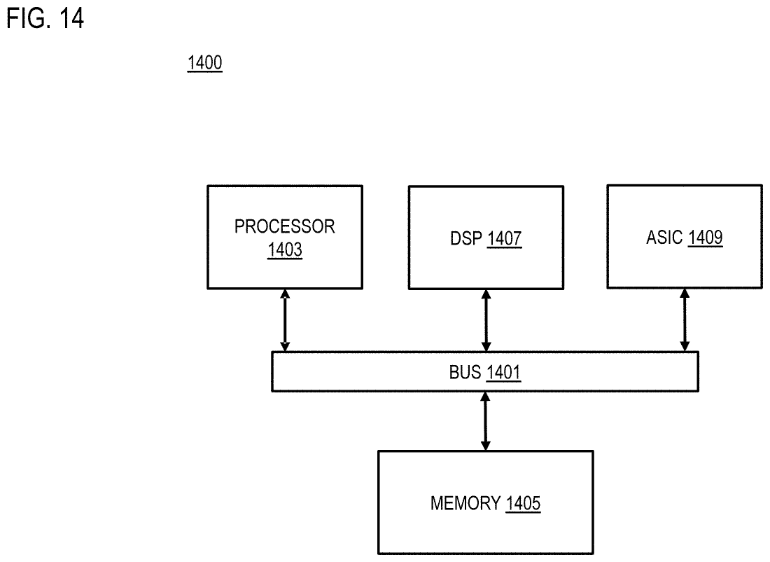

FIG. 3 is a flowchart of a process 300 for detecting slippery roads based on friction measurements, according to one embodiment. In various embodiments, the mapping platform 105, client 117, and/or any of the modules 201-207 may perform one or more portions of the process 300 and may be implemented in, for instance, a chip set including a processor and a memory as shown in FIG. 14. As such, the mapping platform 105, client 117, and/or any of the modules 201-207 can provide means for accomplishing various parts of the process 300, as well as means for accomplishing embodiments of other processes described herein in conjunction with other components of the system 100. Although the process 300 is illustrated and described as a sequence of steps, it is contemplated that various embodiments of the process 300 may be performed in any order or combination and need not include all of the illustrated steps.

In step 301, the traction module 201 detects or otherwise receives a traction loss of a vehicle traveling on a road link. The traction loss is detected using a first sensor. By of example, the first sensor detects an activation of a braking system, a stability control system, or a combination thereof to detect the traction loss. In other words, the traction loss sensor can be an ABS sensor, ESC sensor, and/or any other sensor capable detection that a traction loss between a vehicle and a road surface. Traction loss, for instance, refers to a loss of tire grip between a vehicle's tire and the road surface. In generally, traction loss is a binary condition (e.g., either tire grip is lost or not lost between the tire and the road surface). A traction loss can result in a skid of the vehicle. In one embodiment, the traction loss is a detected as a point-based traction loss event associated with a location of the traction loss. For example, the location of the traction loss can be determined based on a point at which one or more of the tires skids or no longer provides vehicle power to the ground.

In step 303, the friction module 203 measures or otherwise receives a coefficient of friction between the vehicle and a road surface of the road link. The coefficient of friction is measured using a second sensor. By way of example, the coefficient of friction is measured as a continuous range of values. This range of values can be between a designated range such as, but not limited to, a range between 0 and 1 where 0 indicates a complete traction loss and 1 indicates maximum tire grip. In other words, the range of values of the coefficient of friction represents a measured amount of friction between the vehicle's tires and the road surface. A continuous value indicates that the coefficient of friction can be any real value in the specified range. In one embodiment, the coefficient of friction is continuously monitored as the vehicle travels. In one embodiment, the second sensor detects the coefficient of friction based on a tire grip, a wheelspin, or a combination thereof of the vehicle. For example, an amount of wheelspin of any of the tires of the vehicle can indicate how much friction there is between the tires (e.g., less wheelspin=more tire grip/friction, and more wheel-spin=less tire grip/friction). In comparison, in one embodiment, traction loss could result in maximum wheel spin).

In addition or alternatively, the second sensor for measuring coefficient of friction includes an imaging sensor, a thermal sensor, or a combination thereof. For example, an image sensor can capture images of the road and then process the images to determine whether there are materials (e.g., water, ice, snow, oil, debris, etc.) on the road that can affect the friction between the vehicle and road surface. As another example, a thermal sensor can detect the temperatures of the road surface that may be associated with a coefficient of friction (e.g., colder road surfaces have less friction which warmer road surface have more friction). In one embodiment, one or more of these sensors can be used alone or in combination with the tire grip sensor or indicator to determine a coefficient of friction. For example, the individual sensors can be fused into a combined coefficient of friction. Alternatively, individual sensors can be assessed independently such that the separate coefficients of friction of each sensor type can be aggregated (e.g., statistically or via other aggregation scheme such as but not limited to voting mechanisms or the like).

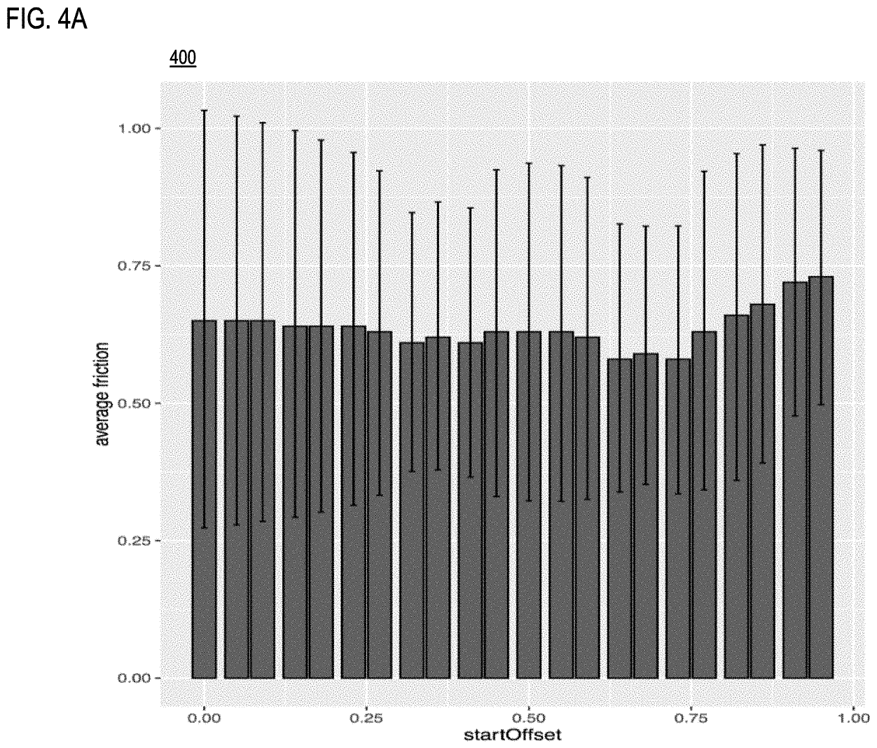

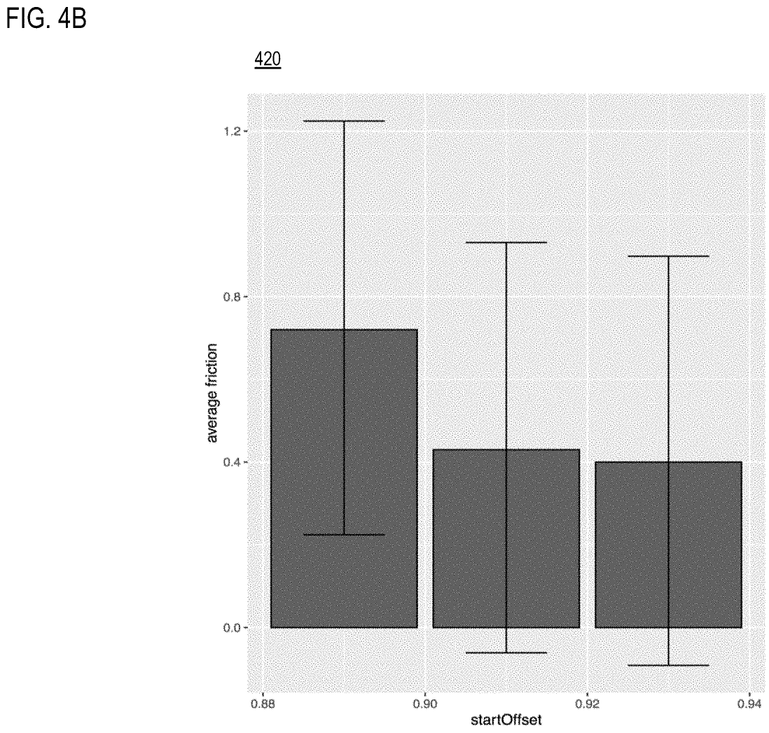

FIGS. 4A and 4B are diagrams of friction measurements over example road links, according to various embodiments. FIG. 4A illustrates an example friction plot 400 for several vehicles traveling on an example road link. As shown, the x-axis is the link offset, and the y-axis is the average friction computed from several friction reports (e.g., from multiple vehicles 101). In this example, the average friction is >0.6 from the start of the link (i.e., offset 0) to the end of the link (i.e., offset 1). Offset, for instance, refers to a percentage from the start of the link to a selected position on the link. As shown, sometimes the friction coefficient goes slightly above 1 because of the maximum extend of the error bars. The error bars can be viewed as standard deviation of the estimates.

FIG. 4B depicts an example friction plot 420 for another road link. As in FIG. 4A, the x-axis is the link offset, and the y-axis is the average friction computed from several friction reports. On this link, the start of the link is not as slippery as the end of the link. At link start, the coefficient of friction is >0.7 while at the end of the link it is 0.4.

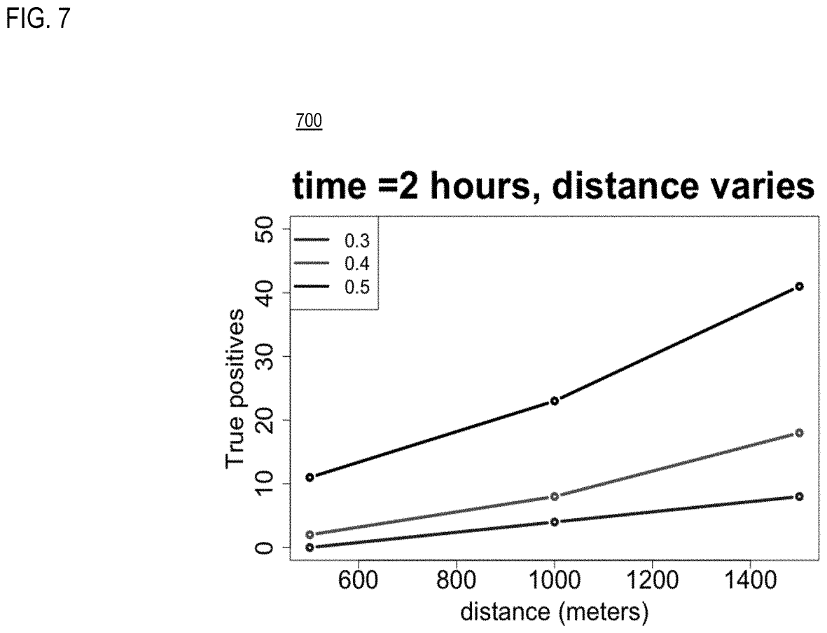

In step 305, the fusion module 205 fuses the traction loss with the coefficient of friction to detect the slippery road condition on the road link. In other words, the fusion module 205 uses the results of both the traction loss detection and friction measurements to determine slippery road conditions. An embodiment in which only the friction measurement is used is described with respect to FIG. 7 below.

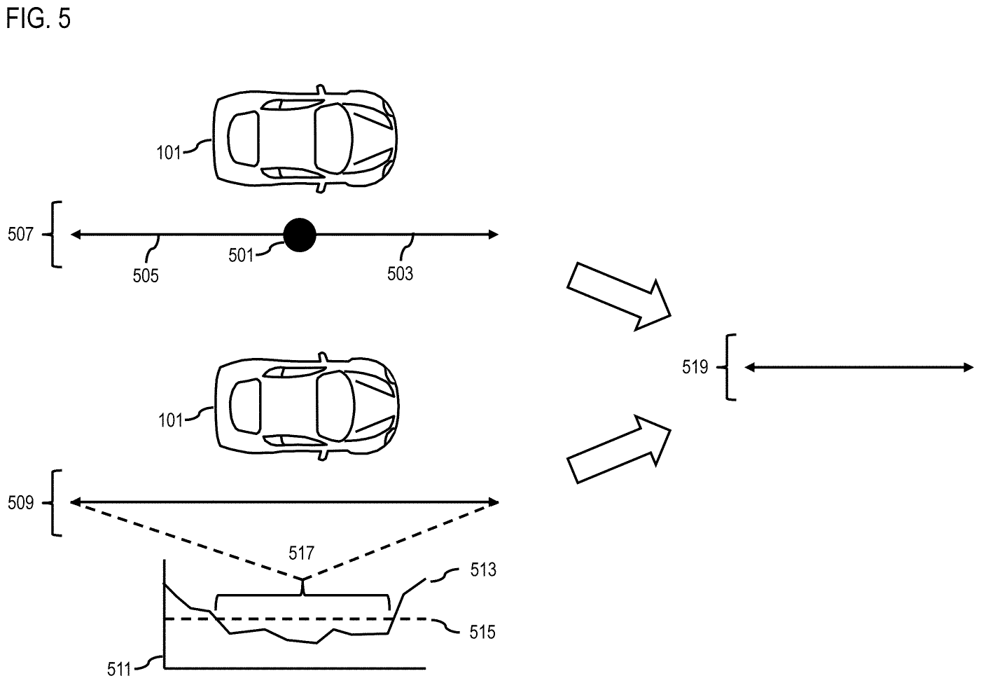

In one embodiment, to perform the fusion, the fusion module 205 converts the point-based traction loss event to a line-based traction loss event by extending a forward line, a backward line, or a combination thereof from the location of the traction loss. For example, FIG. 5 is a diagram illustrating an example of fusing traction loss and friction measurements, according to one embodiment. In the example of FIG. 5, a vehicle 101 is traveling on a road link and experiences a traction loss event 501 that is detected, for instance, by an ABS sensor or an ESC sensor indicating a loss of traction. The fusion module 205 can extend a forward line 503 and a backward line 505 a predetermined distance from the location of the detected traction loss event 501 to create a line-based traction loss event 507.

The fusion module 205 then matches the line-based traction loss event to a coefficient of friction line based on location and/or time (e.g. spatio-temporal constraints). By way of example, the coefficient of friction line represents a line on the road link over which the coefficient of friction value is below a threshold value. The coefficient of friction line can be generated from continuous friction measurements collected by the same vehicle or other vehicles traveling the same road link as the detected traction loss event or within a threshold spatial and/or temporal threshold from the detected traction loss event. In the example of FIG. 5, the coefficient of friction line 509 is generated by the vehicle 101 based a set of collected friction measurements represented in the friction plot 511. The x-axis of the plot is the link offset and the y-axis is the measured coefficient of friction. The curve 513 represents the friction values over the length of the link, and a threshold value 515 can be used to define what portion of the link is slippery. For example, the extent 517 of the link is associated with a friction values below the threshold value 515. As a result, the extent 517 of the link can be used to define the coefficient of friction line 509.

The fusion module 205 can then generate a line fusion of the line-based traction loss and the coefficient of friction line based on the matching (e.g., spatio-temporal matching). The fusing of the traction loss with the coefficient of friction is based on the line fusion. The line fusion, for instance, indicates a line along which both the line-based traction loss event and the coefficient of friction line overlap or otherwise both confirm slippery conditions. As shown in FIG. 5, the matched portions of the line-based traction loss event 507 and the coefficient of friction line 509 are fused to make the line fusion 519 that represents the portion of the link that has confirmed slippery conditions according to the embodiments described herein.

In summary, in one embodiment, slippery alerts that are derived from traction loss events indicated by ABS and ESC can be fused with slippery alerts that are derived from coefficient of friction measures as follows:
The loss of traction locations from ABS and ESC are latitude/longitude points. For the slippery alert, the fusion module 205 can convert the latitude/longitude points into lines by projecting a predetermined distance (e.g., 25 m or any other designated value) in both directions from the latitude/longitude point. When using 25 m projections, the point-based traction loss events become 50 m slippery events. The 25 m is provided by way of illustration and is configurable.
The locations where the probability of slipperiness is greater than a predetermined threshold (e.g., >0.6) are also converted to lines instead of a point.
Lastly, the merging of slippery line events from traction loss and coefficient of friction is conducted if they are on the same or connected map link that meeting matching criteria such as, but not limited to, having the same travel direction and are within 30 minutes and at least 50 m of each other.

In one embodiment, the threshold value applied to coefficient of friction can be determined using any means including by default or empirically from data. For example, one example data set may include both traction loss-based events and coefficient based events as illustrated in Table 1 below:

TABLE 1

Traction loss-based events
889 slippery events
275 road links
Coefficient of friction-based events
(e.g., coefficient of friction ≤ 0.7)
26150 raw data points
6210 road links

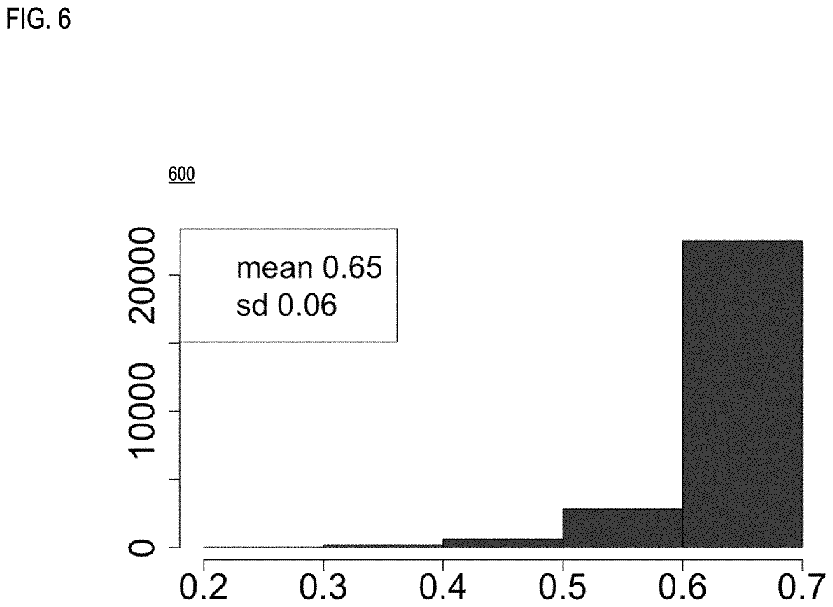

The distribution of the coefficient of friction-based events in Table 1 illustrated in the distribution 600 of FIG. 6. The x-axis of the distribution 600 is the coefficient of friction and the y-axis is a frequency of data points falling within a coefficient window indicated on the x-axis. The system 100 can correlate both datasets (e.g., traction loss-based events and coefficient of friction-based events of Table 1) and determine a threshold on coefficient of friction that can be used to generate slippery events based on true positive matches. The true positive matches are where both traction loss and coefficient of friction confirmed a slippery event as shown in the plot 700 of FIG. 7.

Based on the above plots 600 and 700, and the fact that roads become more slippery as the coefficient of friction goes closer to 0, the system 100 can recommend a coefficient of friction threshold value. For example, based on the example data sets of Table 1, the recommended value can be a coefficient of friction equal to 0.4 and time difference of two hours (e.g., temporal constraint) and spatial constraint of 1.5 km to aggregate slippery observations from traction loss and coefficient of friction.

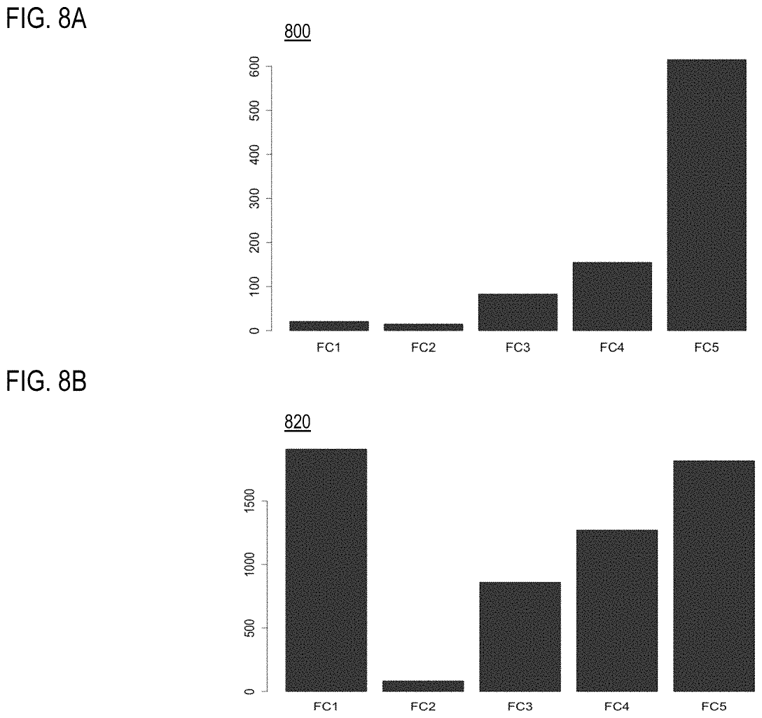

In one embodiment, the fusion of coefficient of friction and traction loss can advantageously detect slippery events on higher function class roads (e.g., highways) where there are relatively fewer user driving behavior events (e.g., high acceleration or braking) that would trigger a traction loss. For example, FIG. 8A illustrates a distribution 800 of slippery road events versus function class determined from traction loss-based events and FIG. 8B illustrates a distribution 820 of slippery road events versus function class determined from coefficient of friction-based events, according to one embodiment. As shown in the distribution 800 of FIG. 8A, the majority of the slippery events based on traction loss are alerted or detected on lower functional class road links. In contrast, as shown in the distribution 820 of FIG. 8B, the majority of the slippery road events based on a threshold on a coefficient of friction are alerted or detected on the highest function class (e.g., highways).

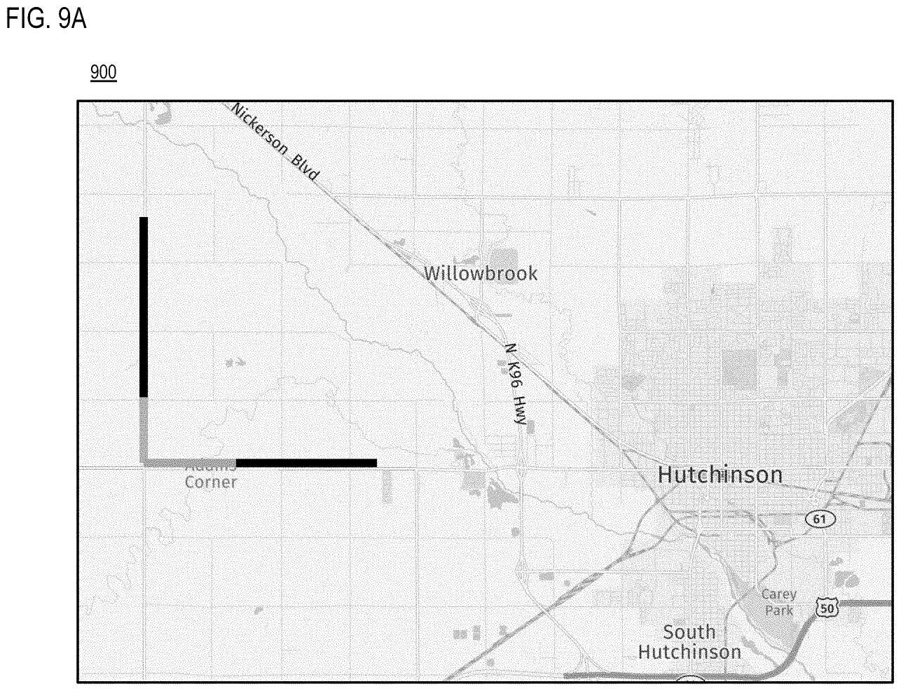

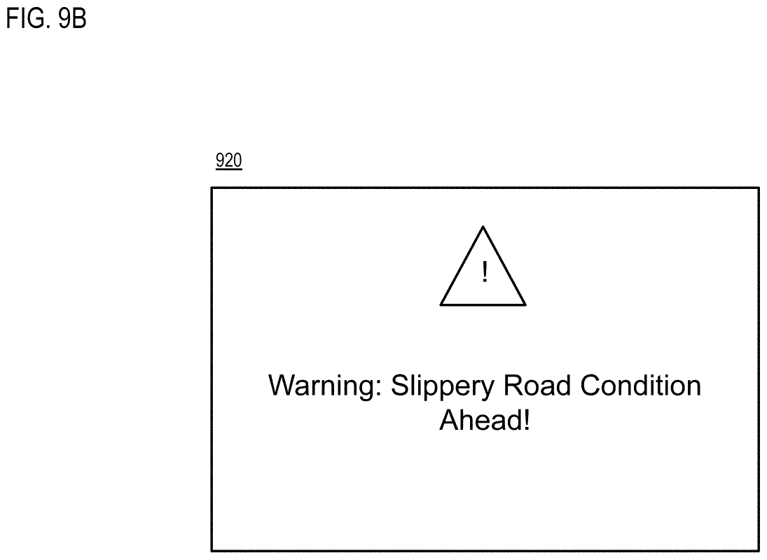

In step 307, the output module 207 provides the detected slippery road condition as an output. In one embodiment, the output can be provided for generating map data or a map layer of a geographic database to indicate the slippery road condition of the road link. Then, the output module 207 can provide data for a mapping user interface to present a representation of the slippery road condition. FIG. 9A illustrates an example mapping user interface 900 that displays a road network of a geographic area. The system 100 can monitor for slippery road conditions based on coefficient of friction measurements according to the embodiments described herein, and then present the determined slippery road data in the user interface 900. In this example, roads associated with the highest level of slipperiness (e.g., coefficient of friction below a threshold value associated with the highest level) are highlighted in a darker shade (or color) while road links/segments with lower levels of slipperiness (e.g., coefficient of friction below a higher threshold value) are highlighted in a lighter shade (or color). It is noted that the representations of slippery road conditions based on shade or color is provided by way of illustration. It is contemplated that the output module 207 can use any representation of a slippery road condition or associated levels of slipperiness.

In another embodiment, the slippery road data can be used to present alerts of upcoming slippery road conditions. For example, slippery road conditions can be detected from coefficient of friction reports from vehicles previously traveling on the road link within a designated time period from the current time). Detected slippery road conditions can then be presented to other vehicles as they approach the corresponding road link within a proximity threshold. FIG. 9B illustrates an example alert user interface 920 that can be presented on a device (e.g., UE 113 or other equivalent component) of an approaching vehicle.

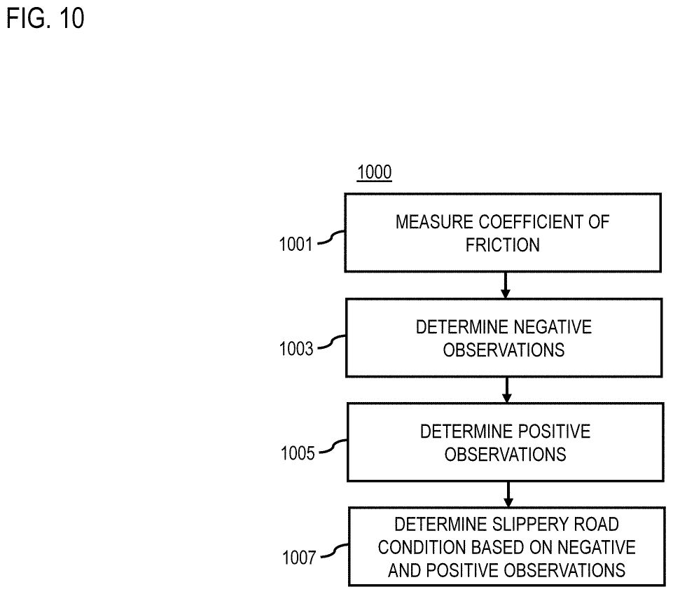

FIG. 10 is a flowchart of a process 1000 for detecting slippery road conditions using negative observations and positive observations determined from friction measurements, according to one embodiment. In various embodiments, the mapping platform 105, client 117, and/or any of the modules 201-207 may perform one or more portions of the process 1000 and may be implemented in, for instance, a chip set including a processor and a memory as shown in FIG. 14. As such, the mapping platform 105, client 117, and/or any of the modules 201-207 can provide means for accomplishing various parts of the process 1000, as well as means for accomplishing embodiments of other processes described herein in conjunction with other components of the system 100. Although the process 1000 is illustrated and described as a sequence of steps, it is contemplated that various embodiments of the process 1000 may be performed in any order or combination and need not include all of the illustrated steps.

The process 1000 illustrates an example in which the coefficient of friction can be used alone without fusing with traction loss data to determine slippery road conditions. In particular, the process 1000 is based on determining negative observations of a slippery road conditions. It is noted that the negative observations described herein can also be used in combination with embodiments that fuse coefficient of friction with traction loss data.

As described above, a negative observation of a slippery road condition refers to determining that a road link does not meet the criteria for classification for being slippery. This is in contrast to when no data is determined or reported for road link to determine a slippery road condition. With negative observations taken into consideration which are effectively areas that are marked as not slippery (e.g., coefficient of friction>a threshold value such as 0.4 or any other designated value), the mapping platform 105 can obtain more observations, for instance, to increase the accuracy and/or confidence of a slippery road alert. In one embodiment, for each segment (e.g., 5 m) of a road link, the mapping platform 105 can count the number of vehicles reporting slippery (e.g., coefficient of friction<=a threshold value such as 0.4 or any other designated value) and the number of vehicle reporting not slippery (e.g., coefficient of friction>a threshold value such as 0.4 or any other designated value) and compute the probability of slipperiness for the segment as positive observations count/(positive+negative observation count).

If the above probability is greater than a threshold (e.g., example 0.6), the mapping platform 105 can report a slipperiness alert based on the coefficient of friction approach. Otherwise, the mapping platform 105 can report a not slippery based on the coefficient of friction approach.

The steps of the process 1000 are summarized below.

In step 1001, the friction module 203 measures or otherwise receives a coefficient of friction between a vehicle and a road surface of the road link. The coefficient of friction is measured using a sensor.

In step 1003, the fusion module 205 determines a negative observation of the slippery road condition based on determining that the coefficient of friction is above a threshold value. The negative observation, for instance, indicates that the slippery road condition has not been detected based on the measured coefficient of friction. In an embodiment, that uses data fusion, the fusing the traction loss with the coefficient of friction to detect the slippery road condition on the road link is further based on the negative observation.

In step 1005, the fusion module 205 can optionally determine a positive observation of the slippery road condition based on determining that another measured coefficient of friction is below a threshold value. The positive observation indicates that the slippery road condition has been detected based on the other measured coefficient of friction. The positive observation indicates that the slippery road condition has been detected based on the other measured coefficient of friction. In an embodiment that uses data fusion, the fusing the traction loss with the coefficient of friction to detect the slippery road condition on the road link is further based on the positive observation.

In step 1007, the fusion module 205 determines the slippery road condition of the road link based on the negative observation, the positive observation, or a combination thereof as described above.

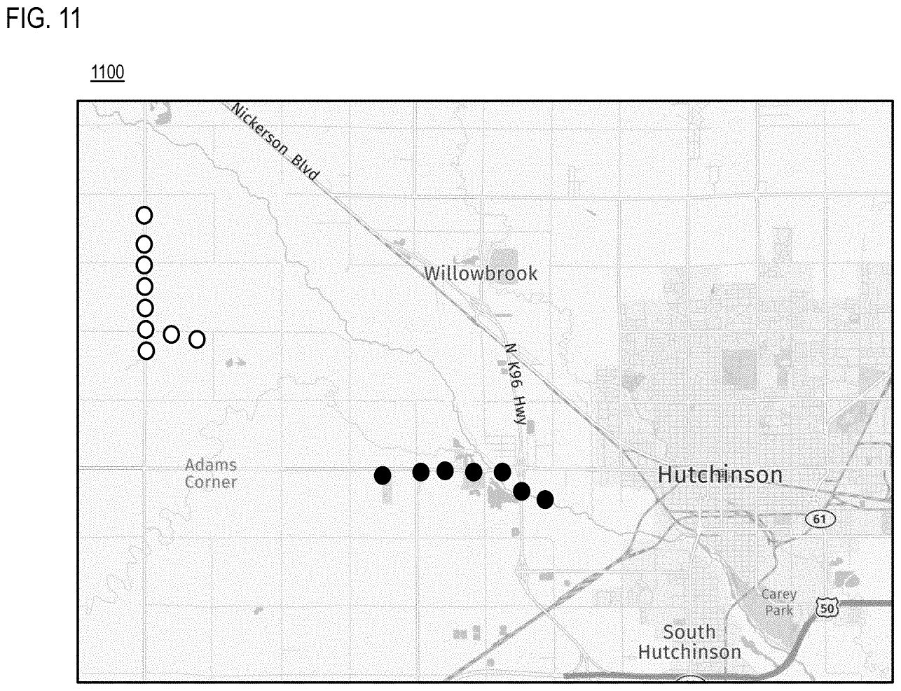

FIG. 11 is a diagram of an example user interface 1100 for presenting negative and positive observations of slippery road conditions based on negative observations and positive observations, according to one embodiment. In the example of FIG. 11, coefficient of friction data is collected from a road network. Positive observations of road slipperiness (e.g., coefficient of friction<=a threshold value such as 0.4 or any other designated value) are indicated by white circles, and negative observation of road slipperiness (e.g., coefficient of friction>a threshold value such as 0.4 or any other designated value) is indicated by black circles. By using both negative and positive observations, the mapping platform 105 advantageously increase the number of observations as well as the data coverage area available for classifying road links as having or not having slippery conditions.

Returning to FIG. 1, as shown, the system 100 includes a mapping platform 105 for detecting slippery road conditions from friction measurements according to the various embodiments described herein. The mapping platform 105 has connectivity over the communication network 121 to the OEM platform 111, services platform 123 that provides one or more services 125 that can use slippery road data 107 to perform one or more functions. By way of example, the services 125 may be third party services and include but is not limited to mapping services, navigation services, travel planning services, notification services, social networking services, content (e.g., audio, video, images, etc.) provisioning services, application services, storage services, contextual information determination services, location based services, information based services (e.g., weather, news, etc.), etc. In one embodiment, the services 125 uses the output of the mapping platform 105 (e.g., slippery road data 107 and/or other hazard data 103) to provide services 125 such as navigation, mapping, other location-based services, etc. to the vehicles 101, UEs 113, and/or client applications 117 executing on the UEs 113.

In one embodiment, the mapping platform 105 may be a platform with multiple interconnected components. The mapping platform 105 may include multiple servers, intelligent networking devices, computing devices, components, and corresponding software for detecting slippery road conditions based on friction measurements according to the various embodiments described herein. In addition, it is noted that the mapping platform 105 may be a separate entity of the system 100, a part of the mapping platform 105, one or more services 125, a part of the services platform 123, or included within components of the vehicles 101 and/or UEs 113.

In one embodiment, content providers 127 may provide content or data (e.g., including geographic data, etc.) to the geographic database 119, OEM platform 111, the mapping platform 105, the services platform 123, the services 125, the vehicles 101, the UEs 113, and/or the client applications 117 executing on the UEs 113. The content provided may be any type of content, such as map content, textual content, audio content, video content, image content, etc. In one embodiment, the content providers 127 may provide content that may aid in detecting slippery road conditions based on friction measurements according to the various embodiments described herein. In one embodiment, the content providers 127 may also store content associated with the mapping platform 105, geographic database 119, mapping platform 105, services platform 123, services 125, and/or any other component of the system 100. In another embodiment, the content providers 127 may manage access to a central repository of data, and offer a consistent, standard interface to data, such as a repository of the geographic database 119.

In one embodiment, the vehicles 101 and/or UEs 113 may execute software client applications 117 to detect traction loss and/or make friction measurements according to the embodiments described herein. By way of example, the client applications 117 may also be any type of application that is executable on the vehicles 101 and/or UEs 113, such as autonomous driving applications, mapping applications, location-based service applications, navigation applications, device control applications, content provisioning services, camera/imaging application, media player applications, social networking applications, calendar applications, and the like. In one embodiment, the client applications 117 may act as a client for the mapping platform 105 and perform one or more functions associated with providing node embeddings alone or in combination with the mapping platform 105.

By way of example, the vehicles 101 and/or UEs 113 is or can include any type of embedded system, mobile terminal, fixed terminal, or portable terminal including a built-in navigation system, a personal navigation device, mobile handset, station, unit, device, multimedia computer, multimedia tablet, Internet node, communicator, desktop computer, laptop computer, notebook computer, netbook computer, tablet computer, personal communication system (PCS) device, personal digital assistants (PDAs), audio/video player, digital camera/camcorder, positioning device, fitness device, television receiver, radio broadcast receiver, electronic book device, game device, or any combination thereof, including the accessories and peripherals of these devices, or any combination thereof. It is also contemplated that the vehicles 101 and/or UEs 113 can support any type of interface to the user (such as “wearable” circuitry, etc.). In one embodiment, the vehicles 101 and/or UEs 113 may be associated with or be a component of a vehicle or any other device.

In one embodiment, the vehicles 101 and/or UEs 113 are configured with various sensors for generating or collecting sensor data 109 (e.g., traction loss and/or friction measurements for processing by mapping platform 105), related geographic data, etc. In one embodiment, the sensed data represent sensor data associated with a geographic location or coordinates at which the sensor data was collected, and the polyline or polygonal representations of detected objects of interest derived therefrom. By way of example, the sensors may include a global positioning sensor for gathering location data (e.g., GPS/GNSS), IMUs, a network detection sensor for detecting wireless signals or receivers for different short-range communications (e.g., Bluetooth, Wi-Fi, Li-Fi, near field communication (NFC) etc.), temporal information sensors, a camera/imaging sensor for gathering image data (e.g., the camera sensors may automatically capture road sign information, images of road obstructions, etc. for analysis), an audio recorder for gathering audio data, velocity sensors mounted on steering wheels of the vehicles, switch sensors for determining whether one or more vehicle switches are engaged, and the like.

Other examples of sensors of the vehicles 101 and/or UEs 113 may include light sensors, orientation sensors augmented with height sensors and acceleration sensor, tilt sensors to detect the degree of incline or decline (e.g., slope) along a path of travel, moisture sensors, pressure sensors, etc. In a further example embodiment, sensors about the perimeter of the vehicles 101 and/or UEs 113 may detect the relative distance of the device or vehicle from a lane or roadway, the presence of other vehicles, pedestrians, traffic lights, potholes and any other objects, or a combination thereof. In one scenario, the sensors may detect weather data, traffic information, or a combination thereof. In one embodiment, the vehicles 101 and/or UEs 113 may include GPS or other satellite-based receivers to obtain geographic coordinates from positioning satellites for determining current location and time. Further, the location can be determined by visual odometry, triangulation systems such as A-GPS, Cell of Origin, or other location extrapolation technologies.

In one embodiment, the communication network 121 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, 5G New Radio networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

By way of example, the mapping platform 105, OEM platform 111, services platform 123, services 125, vehicles 101 and/or UEs 113, and/or content providers 127 communicate with each other and other components of the system 100 using well known, new or still developing protocols. In this context, a protocol includes a set of rules defining how the network nodes within the communication network 121 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

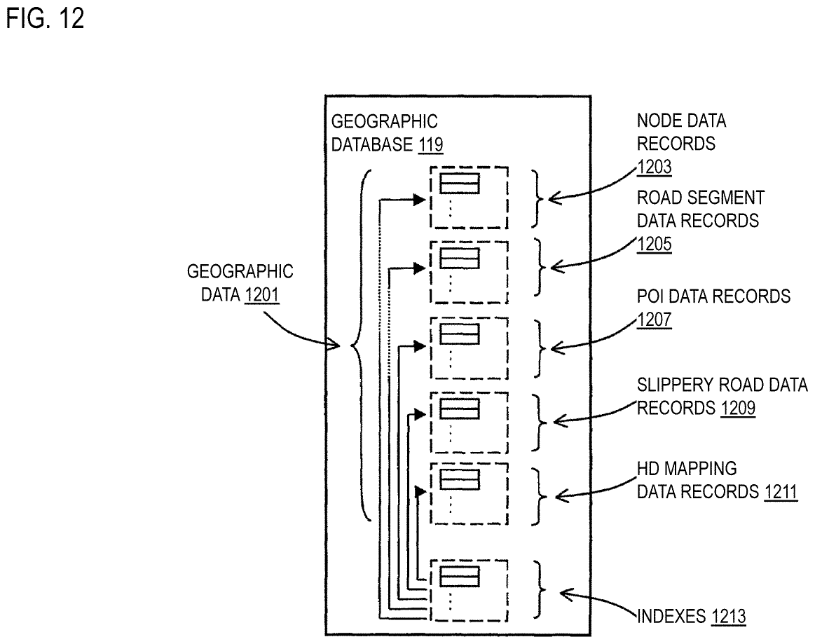

FIG. 12 is a diagram of a geographic database 119, according to one embodiment. In one embodiment, the geographic database 119 includes geographic data 1201 used for (or configured to be compiled to be used for) mapping and/or navigation-related services, such as for detecting slippery road conditions based on friction measurements according to the embodiments described herein. For example, the map data records stored herein can be used to determine the semantic relationships among the map features, attributes, categories, etc. represented in the geographic data 1201. In one embodiment, the geographic database 119 include high definition (HD) mapping data that provide centimeter-level or better accuracy of map features. For example, the geographic database 119 can be based on Light Detection and Ranging (LiDAR) or equivalent technology to collect billions of 3D points and model road surfaces and other map features down to the number lanes and their widths. In one embodiment, the HD mapping data (e.g., HD data records 1211) capture and store details such as the slope and curvature of the road, lane markings, roadside objects such as signposts, including what the signage denotes. By way of example, the HD mapping data enable highly automated vehicles to precisely localize themselves on the road.

In one embodiment, geographic features (e.g., two-dimensional or three-dimensional features) are represented using polylines and/or polygons (e.g., two-dimensional features) or polygon extrusions (e.g., three-dimensional features). In one embodiment, these polylines/polygons can also represent ground truth or reference features or objects (e.g., signs, road markings, lane lines, landmarks, etc.) used for visual odometry. For example, the polylines or polygons can correspond to the boundaries or edges of the respective geographic features. In the case of a building, a two-dimensional polygon can be used to represent a footprint of the building, and a three-dimensional polygon extrusion can be used to represent the three-dimensional surfaces of the building. Accordingly, the terms polygons and polygon extrusions as used herein can be used interchangeably.

In one embodiment, the following terminology applies to the representation of geographic features in the geographic database 119.

“Node”—A point that terminates a link.

“Line segment”—A straight line connecting two points.

“Link” (or “edge”)—A contiguous, non-branching string of one or more line segments terminating in a node at each end.

“Shape point”—A point along a link between two nodes (e.g., used to alter a shape of the link without defining new nodes).

“Oriented link”—A link that has a starting node (referred to as the “reference node”) and an ending node (referred to as the “non reference node”).

“Simple polygon”—An interior area of an outer boundary formed by a string of oriented links that begins and ends in one node. In one embodiment, a simple polygon does not cross itself.

“Polygon”—An area bounded by an outer boundary and none or at least one interior boundary (e.g., a hole or island). In one embodiment, a polygon is constructed from one outer simple polygon and none or at least one inner simple polygon. A polygon is simple if it just consists of one simple polygon, or complex if it has at least one inner simple polygon.

In one embodiment, the geographic database 119 follows certain conventions. For example, links do not cross themselves and do not cross each other except at a node. Also, there are no duplicated shape points, nodes, or links. Two links that connect each other have a common node. In the geographic database 119, overlapping geographic features are represented by overlapping polygons. When polygons overlap, the boundary of one polygon crosses the boundary of the other polygon. In the geographic database 119, the location at which the boundary of one polygon intersects they boundary of another polygon is represented by a node. In one embodiment, a node may be used to represent other locations along the boundary of a polygon than a location at which the boundary of the polygon intersects the boundary of another polygon. In one embodiment, a shape point is not used to represent a point at which the boundary of a polygon intersects the boundary of another polygon.

As shown, the geographic database 119 includes node data records 1203, road segment or link data records 1205, POI data records 1207, slippery road data records 1209, HD mapping data records 1211, and indexes 1213, for example. More, fewer, or different data records can be provided. In one embodiment, additional data records (not shown) can include cartographic (“carto”) data records, routing data, and maneuver data. In one embodiment, the indexes 1213 may improve the speed of data retrieval operations in the geographic database 119. In one embodiment, the indexes 1213 may be used to quickly locate data without having to search every row in the geographic database 119 every time it is accessed. For example, in one embodiment, the indexes 1213 can be a spatial index of the polygon points associated with stored feature polygons.

In exemplary embodiments, the road segment data records 1205 are links or segments representing roads, streets, or paths, as can be used in the calculated route or recorded route information for determination of one or more personalized routes. The node data records 1203 are end points (for example, representing intersections or an end of a road) corresponding to the respective links or segments of the road segment data records 1205. The road link data records 1205 and the node data records 1203 represent a road network, such as used by vehicles, cars, and/or other entities. Alternatively, the geographic database 119 can contain path segment and node data records or other data that represent pedestrian paths or areas in addition to or instead of the vehicle road record data, for example.

The road/link segments and nodes can be associated with attributes, such as geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database 119 can include data about the POIs and their respective locations in the POI data records 1207. The geographic database 119 can also include data about places, such as cities, towns, or other communities, and other geographic features, such as bodies of water, mountain ranges, etc. Such place or feature data can be part of the POI data records 1207 or can be associated with POIs or POI data records 1207 (such as a data point used for displaying or representing a position of a city).

In one embodiment, the geographic database 119 can also include slippery road data records 1209 for storing sensor data 109, slippery road data 107 (e.g., slippery road classifications and/or alerts), and/or any other data that is used or generated according to the embodiments described herein. By way of example, the slippery road data records 1209 can be associated with one or more of the node records 1203, road segment records 1205, and/or POI data records 1207 to associate the detected slippery road conditions and/or traction loss/friction measurement data with specific places, POIs, geographic areas, and/or other map features. In this way, the slippery road data records 1209 can also be associated with the characteristics or metadata of the corresponding records 1203, 1205, and/or 1207.

In one embodiment, as discussed above, the HD mapping data records 1211 model road surfaces and other map features to centimeter-level or better accuracy. The HD mapping data records 1211 also include ground truth object models that provide the precise object geometry with polylines or polygonal boundaries, as well as rich attributes of the models. These rich attributes include, but are not limited to, object type, object location, lane traversal information, lane types, lane marking types, lane level speed limit information, and/or the like. In one embodiment, the HD mapping data records 1211 are divided into spatial partitions of varying sizes to provide HD mapping data to end user devices with near real-time speed without overloading the available resources of the devices (e.g., computational, memory, bandwidth, etc. resources).

In one embodiment, the HD mapping data records 1211 are created from high-resolution 3D mesh or point-cloud data generated, for instance, from LiDAR-equipped vehicles. The 3D mesh or point-cloud data are processed to create 3D representations of a street or geographic environment at centimeter-level accuracy for storage in the HD mapping data records 1211.

In one embodiment, the HD mapping data records 1211 also include real-time sensor data collected from vehicles 101 in the field (e.g., directly or via an OEM platform 111). The real-time sensor data, for instance, integrates real-time traction loss data, friction measurements, traffic information, weather, and road conditions (e.g., potholes, road friction, road wear, etc.) with highly detailed 3D representations of street and geographic features to provide precise real-time data (e.g., including probe trajectories) also at centimeter-level accuracy. Other sensor data can include vehicle telemetry or operational data such as windshield wiper activation state, braking state, steering angle, accelerator position, and/or the like.

In one embodiment, the geographic database 119 can be maintained by the content provider 127 in association with the services platform 123 (e.g., a map developer). The map developer can collect geographic data to generate and enhance the geographic database 119. There can be different ways used by the map developer to collect data. These ways can include obtaining data from other sources, such as municipalities or respective geographic authorities. In addition, the map developer can employ field personnel to travel by vehicle along roads throughout the geographic region to observe features and/or record information about them, for example. Also, remote sensing, such as aerial or satellite photography, can be used.

The geographic database 119 can be a master geographic database stored in a format that facilitates updating, maintenance, and development. For example, the master geographic database or data in the master geographic database can be in an Oracle spatial format or other format (e.g., capable of accommodating multiple/different map layers), such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF)) to organize and/or configure the data for performing navigation-related functions and/or services, such as route calculation, route guidance, map display, speed calculation, distance and travel time functions, and other functions, by a navigation device, such as by vehicles 101 and/or UEs 113. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

The processes described herein for detecting slippery road conditions based on friction measurements may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

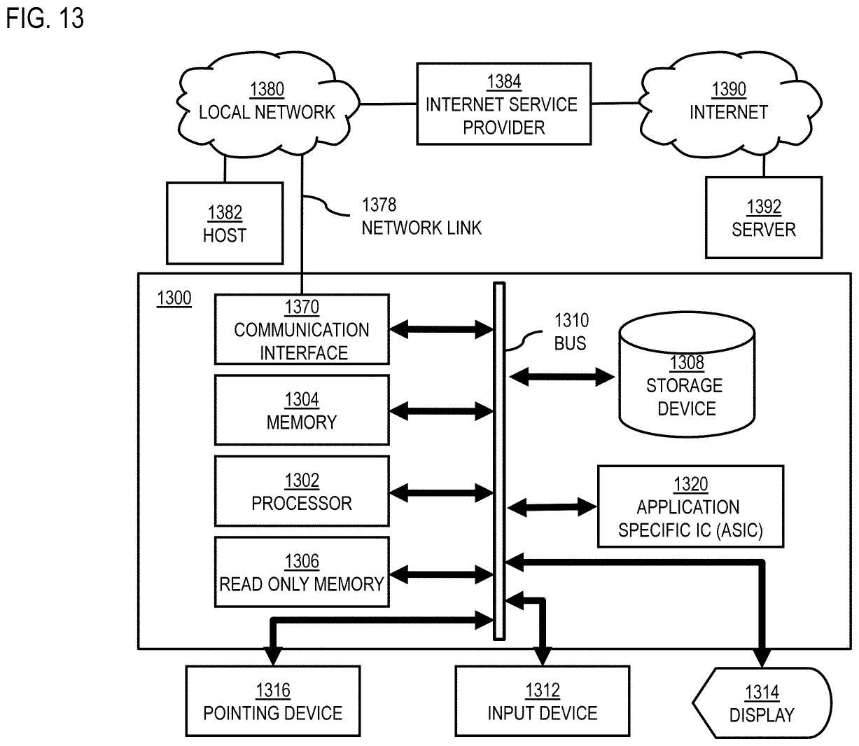

FIG. 13 illustrates a computer system 1300 upon which an embodiment of the invention may be implemented. Computer system 1300 is programmed (e.g., via computer program code or instructions) to detect slippery road conditions based on friction measurements as described herein and includes a communication mechanism such as a bus 1310 for passing information between other internal and external components of the computer system 1300. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 1310 includes one or more parallel conductors of information so that information is transferred quickly among devices coupled to the bus 1310. One or more processors 1302 for processing information are coupled with the bus 1310.

A processor 1302 performs a set of operations on information as specified by computer program code related to detecting slippery road conditions based on friction measurements. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 1310 and placing information on the bus 1310. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 1302, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 1300 also includes a memory 1304 coupled to bus 1310. The memory 1304, such as a random access memory (RAM) or other dynamic storage device, stores information including processor instructions for detecting slippery road conditions based on friction measurements. Dynamic memory allows information stored therein to be changed by the computer system 1300. RAM allows a unit of information stored at a location called a memory address to be stored and retrieved independently of information at neighboring addresses. The memory 1304 is also used by the processor 1302 to store temporary values during execution of processor instructions. The computer system 1300 also includes a read only memory (ROM) 1306 or other static storage device coupled to the bus 1310 for storing static information, including instructions, that is not changed by the computer system 1300. Some memory is composed of volatile storage that loses the information stored thereon when power is lost. Also coupled to bus 1310 is a non-volatile (persistent) storage device 1308, such as a magnetic disk, optical disk or flash card, for storing information, including instructions, that persists even when the computer system 1300 is turned off or otherwise loses power.

Information, including instructions for detecting slippery road conditions based on friction measurements, is provided to the bus 1310 for use by the processor from an external input device 1312, such as a keyboard containing alphanumeric keys operated by a human user, or a sensor. A sensor detects conditions in its vicinity and transforms those detections into physical expression compatible with the measurable phenomenon used to represent information in computer system 1300. Other external devices coupled to bus 1310, used primarily for interacting with humans, include a display device 1314, such as a cathode ray tube (CRT) or a liquid crystal display (LCD), or plasma screen or printer for presenting text or images, and a pointing device 1316, such as a mouse or a trackball or cursor direction keys, or motion sensor, for controlling a position of a small cursor image presented on the display 1314 and issuing commands associated with graphical elements presented on the display 1314. In some embodiments, for example, in embodiments in which the computer system 1300 performs all functions automatically without human input, one or more of external input device 1312, display device 1314 and pointing device 1316 is omitted.

In the illustrated embodiment, special purpose hardware, such as an application specific integrated circuit (ASIC) 1320, is coupled to bus 1310. The special purpose hardware is configured to perform operations not performed by processor 1302 quickly enough for special purposes. Examples of application specific ICs include graphics accelerator cards for generating images for display 1314, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1300 also includes one or more instances of a communications interface 1370 coupled to bus 1310. Communication interface 1370 provides a one-way or two-way communication coupling to a variety of external devices that operate with their own processors, such as printers, scanners, and external disks. In general, the coupling is with a network link 1378 that is connected to a local network 1380 to which a variety of external devices with their own processors are connected. For example, communication interface 1370 may be a parallel port or a serial port or a universal serial bus (USB) port on a personal computer. In some embodiments, communications interface 1370 is an integrated services digital network (ISDN) card or a digital subscriber line (DSL) card or a telephone modem that provides an information communication connection to a corresponding type of telephone line. In some embodiments, a communication interface 1370 is a cable modem that converts signals on bus 1310 into signals for a communication connection over a coaxial cable or into optical signals for a communication connection over a fiber optic cable. As another example, communications interface 1370 may be a local area network (LAN) card to provide a data communication connection to a compatible LAN, such as Ethernet. Wireless links may also be implemented. For wireless links, the communications interface 1370 sends or receives or both sends and receives electrical, acoustic, or electromagnetic signals, including infrared and optical signals, that carry information streams, such as digital data. For example, in wireless handheld devices, such as mobile telephones like cell phones, the communications interface 1370 includes a radio band electromagnetic transmitter and receiver called a radio transceiver. In certain embodiments, the communications interface 1370 enables connection to the communication network 121 for detecting slippery road conditions based on friction measurements.

The term computer-readable medium is used herein to refer to any medium that participates in providing information to processor 1302, including instructions for execution. Such a medium may take many forms, including, but not limited to, non-volatile media, volatile media, and transmission media. Non-volatile media include, for example, optical or magnetic disks, such as storage device 1308. Volatile media include, for example, dynamic memory 1304.

Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization, or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

Network link 1378 typically provides information communication using transmission media through one or more networks to other devices that use or process the information. For example, network link 1378 may provide a connection through local network 1380 to a host computer 1382 or to equipment 1384 operated by an Internet Service Provider (ISP). ISP equipment 1384 in turn provides data communication services through the public, world-wide packet-switching communication network of networks now commonly referred to as the Internet 1390.

A computer called a server host 1392 connected to the Internet hosts a process that provides a service in response to information received over the Internet. For example, server host 1392 hosts a process that provides information representing video data for presentation at display 1314. It is contemplated that the components of system can be deployed in various configurations within other computer systems, e.g., host 1382 and server 1392.

FIG. 14 illustrates a chip set 1400 upon which an embodiment of the invention may be implemented. Chip set 1400 is programmed to detect slippery road conditions based on friction measurements as described herein and includes, for instance, the processor and memory components described with respect to FIG. 13 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 1400 includes a communication mechanism such as a bus 1401 for passing information among the components of the chip set 1400. A processor 1403 has connectivity to the bus 1401 to execute instructions and process information stored in, for example, a memory 1405. The processor 1403 may include one or more processing cores with each core configured to perform independently. A multi-core processor enables multiprocessing within a single physical package. Examples of a multi-core processor include two, four, eight, or greater numbers of processing cores. Alternatively or in addition, the processor 1403 may include one or more microprocessors configured in tandem via the bus 1401 to enable independent execution of instructions, pipelining, and multithreading. The processor 1403 may also be accompanied with one or more specialized components to perform certain processing functions and tasks such as one or more digital signal processors (DSP) 1407, or one or more application-specific integrated circuits (ASIC) 1409. A DSP 1407 typically is configured to process real-world signals (e.g., sound) in real time independently of the processor 1403. Similarly, an ASIC 1409 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1403 and accompanying components have connectivity to the memory 1405 via the bus 1401. The memory 1405 includes both dynamic memory (e.g., RAM, magnetic disk, writable optical disk, etc.) and static memory (e.g., ROM, CD-ROM, etc.) for storing executable instructions that when executed perform the inventive steps described herein to detect slippery road conditions based on friction measurements. The memory 1405 also stores the data associated with or generated by the execution of the inventive steps.

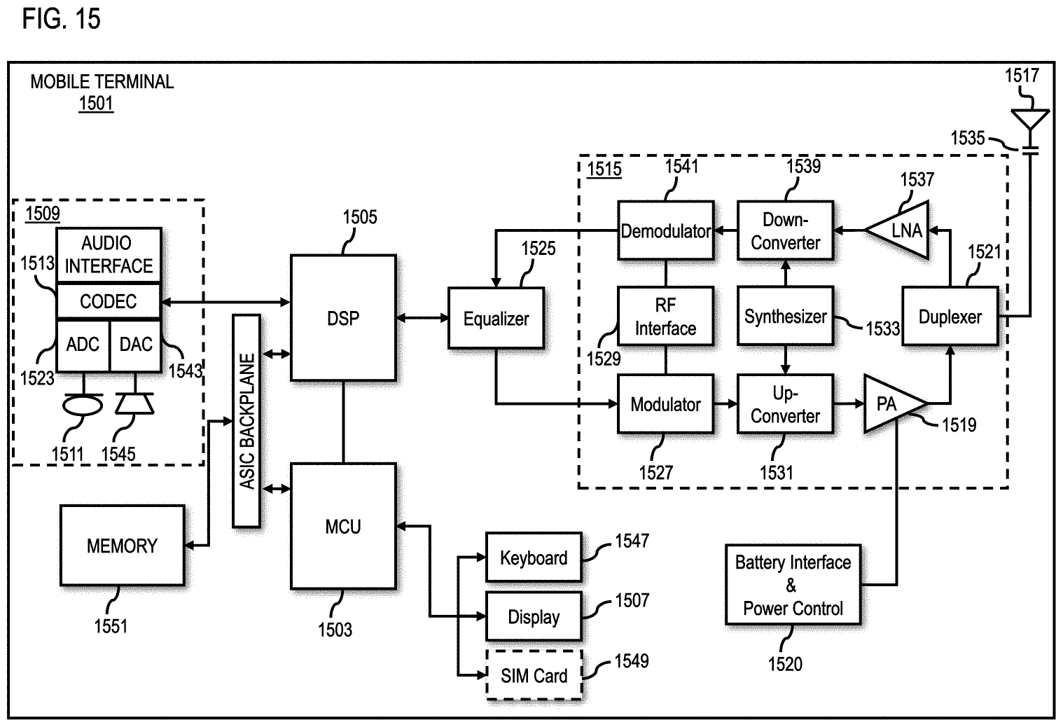

FIG. 15 is a diagram of exemplary components of a mobile terminal 1501 (e.g., a vehicle 101 and/or UE 113 or component thereof) capable of operating in the system of FIG. 1, according to one embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 1503, a Digital Signal Processor (DSP) 1505, and a receiver/transmitter unit including a microphone gain control unit and a speaker gain control unit. A main display unit 1507 provides a display to the user in support of various applications and mobile station functions that offer automatic contact matching. An audio function circuitry 1509 includes a microphone 1511 and microphone amplifier that amplifies the speech signal output from the microphone 1511. The amplified speech signal output from the microphone 1511 is fed to a coder/decoder (CODEC) 1513.

A radio section 1515 amplifies power and converts frequency in order to communicate with a base station, which is included in a mobile communication system, via antenna 1517. The power amplifier (PA) 1519 and the transmitter/modulation circuitry are operationally responsive to the MCU 1503, with an output from the PA 1519 coupled to the duplexer 1521 or circulator or antenna switch, as known in the art. The PA 1519 also couples to a battery interface and power control unit 1520.

In use, a user of mobile station 1501 speaks into the microphone 1511 and his or her voice along with any detected background noise is converted into an analog voltage. The analog voltage is then converted into a digital signal through the Analog to Digital Converter (ADC) 1523. The control unit 1503 routes the digital signal into the DSP 1505 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, 5G New Radio networks, code division multiple access (CDMA), wireless fidelity (WiFi), satellite, and the like.

The encoded signals are then routed to an equalizer 1525 for compensation of any frequency-dependent impairments that occur during transmission though the air such as phase and amplitude distortion. After equalizing the bit stream, the modulator 1527 combines the signal with a RF signal generated in the RF interface 1529. The modulator 1527 generates a sine wave by way of frequency or phase modulation. In order to prepare the signal for transmission, an up-converter 1531 combines the sine wave output from the modulator 1527 with another sine wave generated by a synthesizer 1533 to achieve the desired frequency of transmission. The signal is then sent through a PA 1519 to increase the signal to an appropriate power level. In practical systems, the PA 1519 acts as a variable gain amplifier whose gain is controlled by the DSP 1505 from information received from a network base station. The signal is then filtered within the duplexer 1521 and optionally sent to an antenna coupler 1535 to match impedances to provide maximum power transfer. Finally, the signal is transmitted via antenna 1517 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 1501 are received via antenna 1517 and immediately amplified by a low noise amplifier (LNA) 1537. A down-converter 1539 lowers the carrier frequency while the demodulator 1541 strips away the RF leaving only a digital bit stream. The signal then goes through the equalizer 1525 and is processed by the DSP 1505. A Digital to Analog Converter (DAC) 1543 converts the signal and the resulting output is transmitted to the user through the speaker 1545, all under control of a Main Control Unit (MCU) 1503—which can be implemented as a Central Processing Unit (CPU) (not shown).

The MCU 1503 receives various signals including input signals from the keyboard 1547. The keyboard 1547 and/or the MCU 1503 in combination with other user input components (e.g., the microphone 1511) comprise a user interface circuitry for managing user input. The MCU 1503 runs a user interface software to facilitate user control of at least some functions of the mobile station 1501 to detect slippery road conditions based on friction measurements. The MCU 1503 also delivers a display command and a switch command to the display 1507 and to the speech output switching controller, respectively. Further, the MCU 1503 exchanges information with the DSP 1505 and can access an optionally incorporated SIM card 1549 and a memory 1551. In addition, the MCU 1503 executes various control functions required of the station. The DSP 1505 may, depending upon the implementation, perform any of a variety of conventional digital processing functions on the voice signals. Additionally, DSP 1505 determines the background noise level of the local environment from the signals detected by microphone 1511 and sets the gain of microphone 1511 to a level selected to compensate for the natural tendency of the user of the mobile station 1501.

The CODEC 1513 includes the ADC 1523 and DAC 1543. The memory 1551 stores various data including call incoming tone data and is capable of storing other data including music data received via, e.g., the global Internet. The software module could reside in RAM memory, flash memory, registers, or any other form of writable computer-readable storage medium known in the art including non-transitory computer-readable storage medium. For example, the memory device 1551 may be, but not limited to, a single memory, CD, DVD, ROM, RAM, EEPROM, optical storage, or any other non-volatile or non-transitory storage medium capable of storing digital data.

An optionally incorporated SIM card 1549 carries, for instance, important information, such as the cellular phone number, the carrier supplying service, subscription details, and security information. The SIM card 1549 serves primarily to identify the mobile station 1501 on a radio network. The card 1549 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method for detecting a slippery road condition on a road link comprising:
receiving a traction loss of a vehicle traveling on the road link, the traction loss detected using a first sensor;
receiving a coefficient of friction between the vehicle and a road surface of the road link, the coefficient of friction measured using a second sensor;
fusing the traction loss with the coefficient of friction to detect the slippery road condition on the road link; and
providing the detected slippery road condition as an output.

2. The method of claim 1, wherein the coefficient of friction is measured as a continuous range of values.

3. The method of claim 1, wherein the traction loss is detected as a point-based traction loss event associated with a location of the traction loss.

4. The method of claim 3, further comprising:
converting the point-based traction loss event to a line-based traction loss event by extending a forward line, a backward line, or a combination thereof from the location of the traction loss.

5. The method of claim 4, further comprising:
matching the line-based traction loss event to a coefficient of friction line based on location, wherein the coefficient of friction line represents a line on the road link over which the coefficient of friction value is below a threshold value; and
generating a line fusion of the line-based traction loss and the coefficient of friction line based on the matching,
wherein the fusing of the traction loss with the coefficient of friction is based on the line fusion.

6. The method of claim 1, wherein the slippery road condition is detected to a lane level of the road link.

7. The method of claim 1, wherein the coefficient of friction is continuously monitored as the vehicle travels.

8. The method of claim 1, further comprising:
determining a negative observation of the slippery road condition based on determining that the coefficient of friction is above a threshold value,
wherein the negative observation indicates that the slippery road condition has not been detected based on the measured coefficient of friction; and
wherein the fusing the traction loss with the coefficient of friction to detect the slippery road condition on the road link is further based on the negative observation.

9. The method of claim 1, further comprising:
determining a positive observation of the slippery road condition based on determining that the coefficient of friction is below a threshold value,
wherein the positive observation indicates that the slippery road condition has been detected based on the measured coefficient of friction; and
wherein the fusing the traction loss with the coefficient of friction to detect the slippery road condition on the road link is further based on the positive observation.

10. The method of claim 1, wherein the first sensor detects an activation of a braking system, a stability control system, or a combination thereof to detect the traction loss.

11. The method of claim 1, wherein the second sensor measures the coefficient of friction based on a tire grip, a wheelspin, or a combination thereof of the vehicle.

12. The method of claim 1, wherein the second sensor includes an imaging sensor, a thermal sensor, or a combination thereof.

13. The method of claim 1, further comprising:
generating map data or a map layer of a geographic database to indicate the slippery road condition of the road link; and
providing data for a mapping user interface to present a representation of the slippery road condition.

14. An apparatus for detecting a slippery road condition on a road link comprising:
at least one processor; and
at least one memory including computer program code for one or more programs, the at least one memory and the computer program code configured to, with the at least one processor, cause the apparatus to perform at least the following,
receive a coefficient of friction between a vehicle and a road surface of the road link, the coefficient of friction measured using a sensor;
determine a negative observation of the slippery road condition based on determining that the coefficient of friction is above a threshold value, wherein the negative observation indicates that the slippery road condition has not been detected based on the measured coefficient of friction; and
determine the slippery road condition of the road link based on the negative observation.

15. The apparatus of claim 14, wherein the apparatus is further caused to:
receive a traction loss of the vehicle on the road link; and
fusing the traction loss with the coefficient of friction to detect the slippery road condition on the road link.

16. The apparatus of claim 14, wherein the apparatus is further caused to:
determine a positive observation of the slippery road condition based on determining that another measured coefficient of friction is below a threshold value,
wherein the positive observation indicates that the slippery road condition has been detected based on the another measured coefficient of friction; and
wherein the slippery condition of the road link is further based on the positive observation.

17. The apparatus of claim 15, wherein the traction loss is a detected as a point-based traction loss event associated with a location of the traction loss, and wherein the apparatus is further caused to:
convert the point-based traction loss event to a line-based traction loss event by extending a forward line, a backward line, or a combination thereof from the location of the traction.

18. A non-transitory computer readable storage medium for detecting a slippery road condition on a road link, carrying one or more sequences of one or more instructions which, when executed by one or more processors, cause an apparatus to perform:
detecting a traction loss of a vehicle traveling on the road link using a first sensor;
measuring a coefficient of friction between the vehicle and a road surface of the road link using a second sensor;
fusing the traction loss with the coefficient of friction to detect the slippery road condition on the road link; and
providing the detected slippery road condition as an output.

19. The non-transitory computer readable storage medium of claim 1, wherein the coefficient of friction is measured as a continuous range of values.

20. The non-transitory computer readable storage medium of claim 1, wherein the traction loss is a detected as a point-based traction loss event associated with a location of the traction loss.
